(19) United States
(12) Patent Application Publication
(10) Pub. No.: US 2026/0252880 A1
(43) Pub. Date: Aug. 27, 2026

(54) TRAINING A NEURAL NETWORK TO GENERATE NEW OBSERVATIONS OF A SCENERY

(71) Applicant: Robert Bosch GmbH, Stuttgart (DE)

(72) Inventors: Chaithanya Kumar Mummadi, Coraopolis, PA (US); Dalina John, Diekholzen (DE); Jochen Kall, Hildesheim (DE); Johan Vertens, Freudenstadt (DE); John Miller, Pittsburgh, PA (US); Marcel Schreiber, Neu-Ulm (DE); Maxim Tatarchenko, Berlin (DE); Sherif Abdulatif, Stuttgart (DE)

(21) Appl. No.: 19/546,845

(22) Filed: Feb. 23, 2026

(30) Foreign Application Priority Data
Feb. 27, 2025 (EP) 25 16 0542.4

(51) Int. Cl. G06N 3/08; G06N 3/0464; G06N 3/0475

(52) U.S. Cl. CPC G06N 3/08; G06N 3/0464; G06N 3/0475

(57) ABSTRACT

A method for training a neural network that predicts one or more characteristic values of a specified scenery. In the method: includes: a set of training examples is provided, each containing at least combinations of measurement locations and reference observations of the scenery; for each training example, the corresponding measurement location is supplied to the neural network; the characteristic values obtained in this way are translated with a specified rendering model into an ideal observation of the scenery that is to be expected under idealized conditions starting from the corresponding measurement location; the ideal observation is translated with a measurement model into a real observation of the scenery that is to be expected under realistic conditions starting from the corresponding measurement location; the real observations are compared with the reference observations for the corresponding training example; a deviation determined during this comparison is evaluated using a specified cost function.

### FIELD

The present disclosure relates to the training of neural networks for the generation of synthetic measurement data for a specified scene. These synthetic measurement data can be used, for example, for data augmentation when training further neural networks with regard to specific tasks.

### BACKGROUND INFORMATION

The at least partially automated driving of vehicles or robots on company premises, or even in public road traffic, requires constant monitoring of the environment of the vehicle or robot. For this monitoring, in addition to cameras, radar and lidar sensors are also used. The measurement data are in particular evaluated using for example neural networks.

Such neural networks are trained with a large number of examples of measurement data. It is then expected that they will also deliver usable results (“generalize”) in other cases that were not seen during the training. Not only for the training of such systems but also for the end-to-end test of the processing chain from the measurement data to the executed action of the vehicle or robot, measurement data are required in large quantities and with great variability.

For this purpose, it is desirable to enrich physically recorded measurement data of a specified scenery with synthetically generated measurement data.

### SUMMARY

The present disclosure provides a method for training a neural network configured to predict one or more characteristic values of a specified scenery relating to locations observable from a specified measurement location.

As part of this method, a set of training examples is provided, each containing at least combinations of measurement locations on the one hand and reference observations of the scenery relating to these measurement locations on the other hand. These reference observations can be for example actual observations or simulated observations. For example, radar and lidar measurements can be simulated well because the corresponding interrogation radiation propagates in a straight line and its interaction with objects in the scenery can be calculated geometrically. However, even the propagation of light, from which optical images are generated, can be simulated well, for example with ray tracing.

In a simple application example, the training examples include images of the scenery taken from the corresponding measurement location. The characteristic values predicted by the neural network can then include, for example, the local color and opacity of locations in the scenery, such as on the surface of objects. From the distribution of these local characteristic values, a new image of the scenery from a different perspective can then be calculated, for example.

For each training example, the respective measurement location is supplied to the neural network to be trained. The neural network then provides a prediction for the one or more characteristic values.

The characteristic values obtained in this way are translated, using a specified rendering model, into an ideal observation of the scenery that is to be expected under idealized conditions, starting from the corresponding measurement location.

For example, a geometric rendering model can be used to calculate an image of a scenery from location-dependent distributions of color and opacity in the scenery, taken from any measurement location and from any viewing direction of the same scenery. This is then the image that a perfect imaging system would provide.

However, such a perfect imaging system does not exist. It is rather the case that every real imaging system will provide, instead of an ideal observation, a real observation which is characterized by a process of some kind taking place in the real imaging system. This also applies to the imaging system with which the reference observations in the training examples were recorded. Measuring the training success of the neural network by comparing an ideal image obtained using the predictions of the neural network on the one hand and an actually recorded image on the other would therefore mean chasing an unattainable ideal during training. There is no guarantee that what one can realistically obtain from such a hunt will still be optimal under the given real-world circumstances which deviate significantly from the ideal. It is better to adapt the goal from the outset to what is achievable.

The ideal observation is thus translated, using a measurement model, into a real observation of the scenery that is to expected under realistic conditions, starting from the corresponding measurement location. The measurement model represents a process with which the reference observations in the training examples were obtained. These real observations are then compared with the reference observations for the corresponding training example.

Any deviation determined during this comparison is evaluated using a prespecified cost function. Parameters that characterize the behavior of the neural network architecture are optimized with the goal of improving the evaluation by the cost function during further processing of training examples.

It has been recognized that through the stated adaptation of the goal to what is actually achievable, the training of the neural network yields a result that is closer to the optimum objectively achievable under the given boundary conditions. This counteracts the tendency to focus energy on an unattainable goal, “sacrificing” the achievement of a less significant, but in principle still attainable, goal.

Furthermore, it is avoided that the approximation of a synthetically generated observation, ascertained using the result provided by the neural network, to a real observation results in a conflict of goals with the actual training goal of the neural network. The neural network is trained to achieve the highest-quality result possible that looks realistic in the context of the specified application. The effects that differentiate an actually recorded observation from an ideal observation generally worsen the quality. For example, when observing a scenery optically with real imaging systems, unavoidable imaging errors occur, such as distortions and aberrations of lenses. Taking these imaging errors into consideration can be relocated to the measurement model, according to the method proposed here. This means that the neural network to be trained does not have to learn to produce observations with a degraded quality.

In particular, the training of the neural network is thereby abstracted from the specific physical system used to record the reference observations of the scenery. For this reason, training examples that were recorded in different ways can be mixed in one and the same training session.

For this reason, in an advantageous example embodiment, the set of training examples includes actual observations of the scenery, recorded with a plurality of different devices, as reference observations. In the processing of each training example, a measurement model is selected that is related to the device with which the corresponding actual observation was recorded. This means that the real observation that would have been expected when using this particular device is ascertained. This real observation is compared with the actual observation in the training example, which was recorded with exactly this device.

In a further particularly advantageous example embodiment, at least one training example additionally includes the specification of an observation direction to which the corresponding reference observation relates. This indication of the direction of observation is supplied to the neural network together with the measurement location as input. This can take into account that many observation processes are to be directed in a specific direction, and can only capture a part of the scenery that is observable in that direction. In particular, starting from one and the same measuring point, the observations ascertained in different observation directions can be very different from one another.

In a further advantageous example embodiment, parameters that characterize the behavior of the measurement model are also optimized with the goal of improving the evaluation by the cost function during further processing of training examples. In this way, the real and/or simulated observation process that was at work during recording of the reference observations in the training examples can be learned automatically from the training examples and does not need to be modeled manually. Even if the device used as a reference for actually carried-out observations, such as a camera, is known in principle, such manual modeling, which can also depend on device settings, is very time-consuming. In a further particularly advantageous example embodiment, the measurement model comprises a neural convolutional network that processes its input by sliding application of at least one filter kernel. Such a measurement model can be trained particularly efficiently together with the neural network that is actually to be trained.

In another particularly advantageous example embodiment, the measurement model represents
a physical process and/or simulation process that contributed to the reference observations of the scenery, and/or
a data evaluation that led to the reference observations of the scenery.

As explained above, the physical process, for example when taking optical images as reference observations, includes aberrations, noise and other effects that degrade the image quality compared to the ideal to be expected on the basis of purely geometric considerations. When evaluating radar and lidar data, there is a need to convert the raw data into a frequency representation, for example by means of Fourier transformation. Due to the finite extent of the raw signal on the time scale, this processing can lead to the appearance of components (also known as “sidelobes”) in the frequency representation that do not originate from an object actually present in the scenery.

Both types of effects can be unavoidable when recording actual observations as reference observations.

In a further particularly advantageous example embodiment, reference observations are selected that originate from measurements of the reflection of electromagnetic or acoustic interrogation radiation sent from the measurement location into the scenery. This interrogation radiation can include, in particular, radar radiation, lidar radiation, or ultrasound. While optical imaging systems are often so good that differences from ideal observations hardly matter in the corresponding practical application, radar and lidar measurements in fact almost always show clear differences between real and ideal observations, such as the aforementioned “sidelobes.” This applies in particular to radar measurements in which, unlike lidar measurements, only a spectrum is measured rather than a dense and precise point cloud.

In applications in which the reference observations originate from the reflection of an interrogation radiation, a reflection coefficient and/or a transmission coefficient of at least one location in the scenery can be selected as a characteristic value of the scenery. From spatial distributions of these characteristic values, by geometric construction an ideal observation can be created that is to be expected when interrogating the scenery with interrogation radiation. There is a very clear rendering formula for this, in which gains and losses in intensity in dB can be added or subtracted.

The ideal observation, and/or the real observation, can in particular comprise for example an intensity value of the reflection as a function of the distance and direction of the reflection location to the measurement point. These are the types of data provided by many radar and lidar sensors.

In another particularly advantageous example embodiment, the real observation is enriched, as compared to the ideal observation, by intensity contributions for additional combinations of distance and direction that do not correspond to any real object in the scenery. As explained above, such “sidelobes” can be formed in particular through the evaluation of the raw signals using Fourier transformation. It would be particularly contradictory if the neural network to be trained had to be trained to generate signals from non-existent objects. It is thus much easier to separate, according to the method proposed here, the generation of ideal observations from scenery characteristic values on the one hand, and the further processing of the ideal observations to form real observations on the other.

In a further particularly advantageous example embodiment, at least one location is supplied to the trained measurement network. Optionally, an observation direction can in addition be supplied to the trained neural network. The neural network then provides characteristic values of the scenery as they can be observed from the specified location, and optionally in the specified direction of observation. Using this characteristic value provided by the trained neural network and/or an ideal observation and/or real observation generated from it, a synthetic observation of the scenery is generated. This synthetic observation can in particular correspond, for example, to the generated ideal observation and/or real observation. The synthetically generated observation can serve, in particular, as a new training example for another machine learning model, or also for testing any processing chain for the further processing of observations supplied by one or more sensors. For example, a processing chain mentioned above for processing observations into actions that a vehicle or robot is subsequently supposed to execute can be tested “end-to-end.” Such tests are important in particular for granting approvals for operation in public road traffic.

For this reason, in a further particularly advantageous example embodiment, another machine learning model is trained using the generated synthetic observation of the scenery, and/or the functionality of a technical system for evaluating observations is tested using the generated synthetic observation of the scenery.

Particularly advantageously, a traffic situation is chosen as the scenery. The synthetically generated observation relates to a modification of the traffic situation that constitutes a violation of traffic rules and/or a hazard. It requires a particularly large effort to replicate such modifications in reality in order to obtain actual observations as reference observations, if this is even possible. For example, the modification may relate to a vehicle driving on the lane boundary between two lanes, or driving too close to a vehicle in front.

In a further particularly advantageous example embodiment, at least one local value of at least one location-dependent function, which individually or together with other location-dependent functions form a representation of the scenery, is chosen as a characteristic value. This makes it possible for the neural network being trained to calculate a pictorial reconstruction of the scenery from any perspective. Contributions of probability density functions to such a representation have, per se, a meaning that can be further evaluated particularly well, for example, by a downstream neural network (task network) trained for a specific task.

An example of such a distribution function is a probability density function of a Gaussian distribution, often referred to simply as a “Gaussian function.” Such a function can be characterized, for example, by
three parameters for the spatial shift in the three coordinate directions of Cartesian space,
three parameters for scaling in these three coordinate directions,
four parameters for the orientation of the function in space,
three parameters for specifying the color with which the function's contribution manifests in the superposition, in the three additive primary colors red, green, and blue, and
optionally, in addition speed vectors for a translation and/or rotation

All of these parameters are found in the arguments of the sine, cosine and exponential functions. Therefore, the Gaussian function can easily be differentiated according to these parameters.

It is thus particularly advantageous to choose at least one probability density function of a Gaussian distribution as a location-dependent function.

The method can in particular be wholly or partially computer-implemented. The present disclosure therefore also relates to a computer program comprising machine-readable instructions that, when executed on one or more computers and/or compute instances, cause the computer(s) and/or compute instance(s) to execute the described method. In this sense, control devices for vehicles and embedded systems for technical devices, which are also capable of executing machine-readable instructions, are also to be regarded as computers. Compute instances can, for example, be virtual machines, containers, or serverless execution environments, which can be provided in a cloud in particular.

The present disclosure also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present disclosure are explained in more detail below, together with the description of the preferred exemplary embodiments of the present disclosure, with reference to the figures.

### BRIEF DESCRIPTION OF THE DRAWINGS

FIG. 1 shows an exemplary embodiment of the method 100 for training a neural network 2;

FIG. 2A-2D show simulated radar spectra that can be used as reference observations 4a.

FIG. 3 shows the generation of an ideal observation 4a* with a rendering model 7.

FIG. 4 illustrates the use of a measurement model 8 to generate a real observation 4a**.

### DETAILED DESCRIPTION OF EXAMPLE EMBODIMENTS

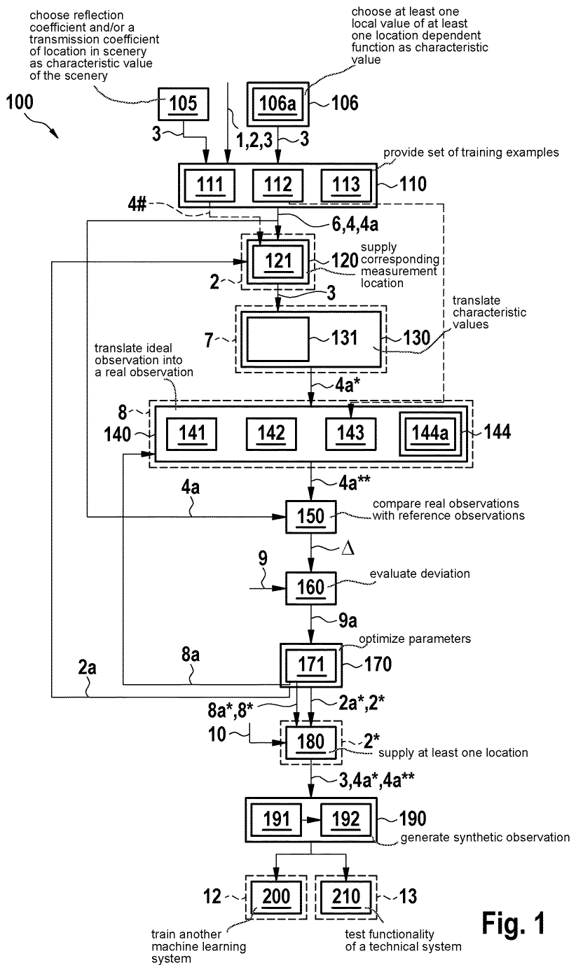

FIG. 1 is a schematic flowchart of an exemplary embodiment of the method 100 for training a neural network 2. This neural network 2 is trained to predict one or more characteristic values 3 of a specified scenery 1 which relate to locations 5 observable from a specified measurement location 4.

According to block 105, a reflection coefficient and/or a transmission coefficient of at least one location in the scenery 1 can be chosen as characteristic value 3 of the scenery 1.

According to block 106, at least one local value of at least one location-dependent function, which individually or together with other location-dependent functions forms a representation of the scenery 1, can be chosen as characteristic value 3. For example, according to block 106a, at least one probability density function of a Gaussian distribution can be chosen as a location-dependent function.

In step 110, a set of training examples 6 is provided. The training examples 6 each contain at least combinations of measurement locations 4 on the one hand and reference observations 4a of the scenery 1 that relate to these measurement locations 4 on the other hand.

According to block 111, at least one training example can additionally include the specification of an observation direction 4 #to which the corresponding reference observation 4a relates.

According to block 112, the set of training examples 6 can include actually carried-out observations of the scenery 1, recorded with a plurality of different devices, as reference observations 4a.

According to block 113, reference observations 4a can be selected which originate from measurements of the reflection of electromagnetic or acoustic interrogation radiation sent from the measurement location 4 into the scenery 1.

In step 120, for each training example 6 the corresponding measurement location 4 is supplied to the neural network 2. The neural network 2 then provides a prediction for the one or more characteristic values 3.

If an observation direction is available according to block 111, this information about the observation direction 4 #according to block 121 can be supplied to the neural network 2 together with the measurement location 4 as input.

In step 130, the characteristic values 3 obtained from the neural network 2 are translated using a specified rendering model 7 into an ideal observation 4a* of the scenery 1 that is to be expected under idealized conditions starting from the corresponding measurement location 4.

According to block 131, the ideal observation 4a* can comprise an intensity value of the reflection as a function of the distance and direction of the reflection location to the measurement location 4.

In step 140, the ideal observation 4a* is translated with a measurement model 8 into a real observation 4a** of the scenery 1 that is to be expected under realistic conditions starting from the corresponding measurement location 4. The measurement model 8 here represents a process by which the reference observations 4a in the training examples 6 were obtained.

According to block 141, the measurement model 8 can include a neural convolutional network that processes its input by sliding application of at least one filter kernel.

According to block 142, the measurement model 8 can represent
a physical process and/or simulation process that has contributed to the reference observations 4a of the scenery 1, and/or
a data evaluation that led to the reference observations 4a of the scenery 1.

Insofar as reference observations 4a were recorded with different devices according to block 112, a measurement model 8 relating to the device with which the observation 4a actually carried out was recorded can be selected, according to block 143, during the processing of each training example 6.

According to block 144, the real observation 4a** can comprise an intensity value of the reflection as a function of the distance and direction of the reflection location to the measurement location 4. According to block 144a, this real observation can be enriched compared to the ideal observation 4a* by intensity contributions for additional combinations of distance and direction that do not correspond to any real object in the scenery 1.

In step 150, the real observations 4a** are compared with the reference observations 4a for the corresponding training example 6. This comparison yields a deviation A.

In step 160, this deviation A is evaluated with a specified cost function 9. An evaluation 9a results.

In step 170, parameters 2a that characterize the behavior of the neural network architecture 2 are optimized with the goal of improving the evaluation 9a by the cost function 9 during further processing of training examples 6. The fully optimized state of the parameters 2a is denoted by reference sign 2a* and defines the fully trained state 2* of the neural network 2. According to block 171, parameters 8a which characterize the behavior of the task network 8 can also be optimized with the goal of improving the evaluation 9a by the cost function 9 during further processing of training examples 6. The fully optimized state of the parameter 8a is indicated by the reference sign 8a* and defines the fully trained state 8* of the measurement model 8. In the example shown in FIG. 1, at least one location 10 is supplied to the trained neural network 2. (Step 180). In step 190, using the characteristic value 3 thereupon provided by the trained neural network 2, and/or an ideal observation 4a* and/or real observation 4a** generated therefrom, a synthetic observation 11 of the scenery 1 is then generated.

According to block 191, a traffic situation, for example, can in particular be selected as the scenery 1. According to block 192, the synthetic observation 11 can then, for example, relate to a modification of the traffic situation that constitutes a violation of traffic rules and/or a hazard.

In the example shown in FIG. 1, in step 200 another machine learning model 12 is trained using the generated synthetic observation 11 of the scenery 1. This additional machine learning model can be set up to solve any task, such as the detection and/or classification of object instances in the scenery 1, or a semantic segmentation of the scenery 1.

Alternatively or in combination with this, in step 210 the functionality of a technical system 13 for the evaluation of observations can be tested using the generated synthetic observation 11 of the scenery 1.

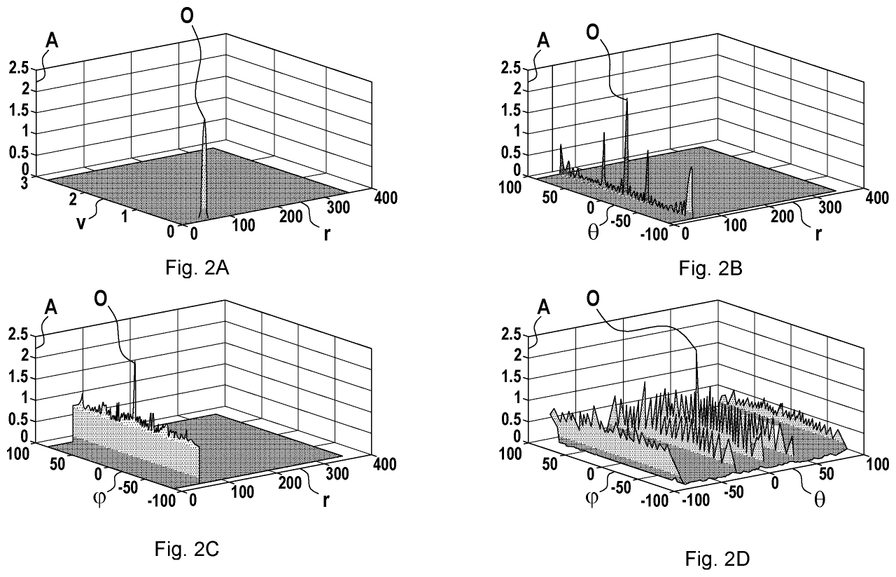

FIGS. 2A-2D shows simulated radar spectra obtained for an exemplary scenery 1 with only a single object. These radar spectra form a so-called “radar cube,” which is a four-dimensional tensor with the dimensions distance r, Doppler velocity v, azimuth angle θ and elevation angle φ. Each value in this cube (tensor) represents an amplitude A of the radar signal measured for the corresponding position. In the plots in FIGS. 2A-2D, for illustration purposes only two dimensions are shown in each case, and the maximum amplitude values were chosen with respect to the two remaining dimensions in each case of the 4D tensor. The portion of the signal relating to the single object in scenery 1 is marked with the reference sign O in each case. The radar spectra can be used as reference observations 4a in the context of the method 100.

In FIG. 2A, the amplitude A is plotted as a function of the Doppler velocity v and the distance r.

In FIG. 2B, the amplitude A is plotted as a function of the azimuth angle θ and the distance r. Here it is particularly clear that there are other peaks in addition to the one relating to the single object in the scenery 1. These peaks, which are also called “sidelobes” and do not correspond to any real object in the scenery 1, are the result of the Fourier transformation (FFT) of the time-dependent radar signal into the representation in FIG. 2B. FIG. 2B shows that a reflection at a certain distance r influences the amplitude values for combinations of this distance r with all azimuth angles θ.

A similar effect can be seen in FIG. 2C, where the amplitude A is plotted as a function of the elevation angle φ and the distance r.

In FIG. 2D, the amplitude A is plotted as a function of the elevation angle q and the azimuth angle θ.

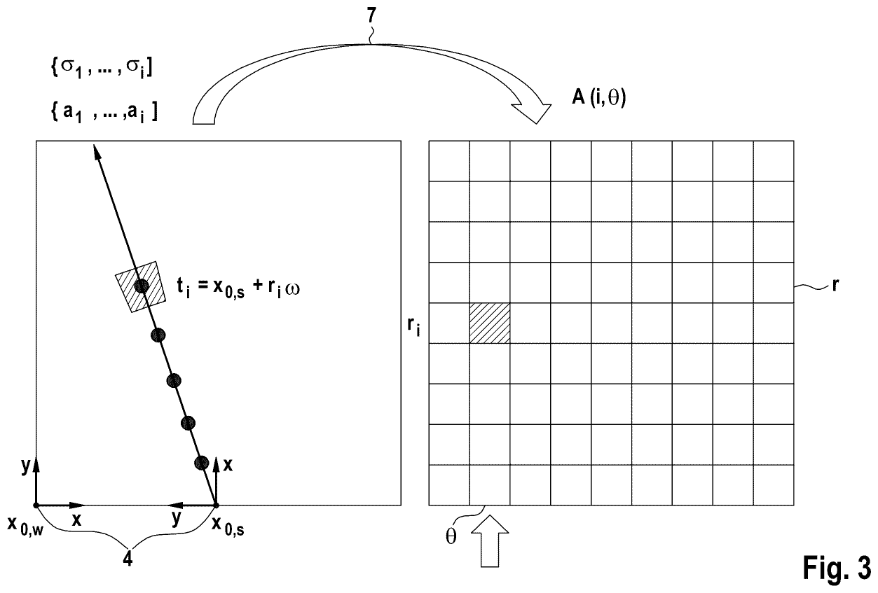

FIG. 3 illustrates how, the amplitude A of a radar signal can be ascertained as a function of the azimuth angle θ and the distance r from a spatial distribution of transmission coefficients α(x, y, z) and reflection coefficients σ(x, y, z) as a function of Cartesian coordinates x, y, z in space. The amplitude A thus ascertained is an ideal observation 4a* that is to be expected starting from a measurement location 4 in the beam direction ω.

The complete plot of amplitude A against azimuth angle θ and distance r can be obtained by considering beams for all combinations of azimuth angle θ and elevation angle φ and taking samples along different positions along each beam. If the distance r is discretized into bins rᵢ with subscripts i, the amplitude A can be written as a function of these subscripts i and the azimuth angle θ:

$$A ( i , θ ) = {g}_{θ} \frac{σ ( {x}_{0 , S} + {r}_{i} ω )}{{r}_{i}^{2}} {\prod }_{{i}^{′} = 1}^{i - 1} {α ( {t}_{{i}^{′}} )}^{2}$$

$$with$$

$${t}_{i} = {x}_{0 , S} + {r}_{i} ω ,$$

where x_{0,S} is the measurement location 4 in the coordinate system of the radar sensor used. This procedure, including the rendering formula for A(i, θ), forms a rendering model 7 in the context of the method 100.

FIG. 3 is drawn in two dimensions for simplicity, i.e. without the elevation angle. Accordingly, the amplitude A also depends only on i and θ. In three-dimensional space, x and ω would be three-dimensional, and the antenna gain g_{θ} would be dependent not only on the azimuth angle θ but also on the elevation angleφ. The amplitude A would then also depend on both angles, i.e. A(i, θ, φ).

In FIG. 3, due to the discretization of the distance r into bins rᵢ, the reflection coefficients σ and the transmission coefficients α are also designated with subscripts 1, . . . , i. x_{0,W} designates the measurement location 4 in world coordinates x, y, z. x_{0,S} designates the measurement location 4 in the coordinate system of the radar sensor used. The sampled locations along the radar beam represent locations 5 in the scenery 1 that can be observed from the measurement location 4.

Thus, if the trained neural network 2 for each location x, y, z in space yields a transmission coefficient α(x, y, z) and a reflection coefficient σ(x, y, z) as local characteristic values 3 of the scenery 1, then an ideal observation 4a* can be ascertained from this, which in principle could be compared with the reference observations 4a. The neural network 2 could be trained to achieve the goal of matching the ideal observations 4a* as closely as possible to the reference observations 4a. However, as explained above, fact that the geometric rendering model does not include the generation of “sidelobes” by the Fourier transform (FFT) would interfere with this comparison, as there is no time-dependent signal to transform in the rendering model. It would contradict the actual training goal of the neural network 2 if it now also had to learn to generate peaks for objects that are not actually present in scenery 1.

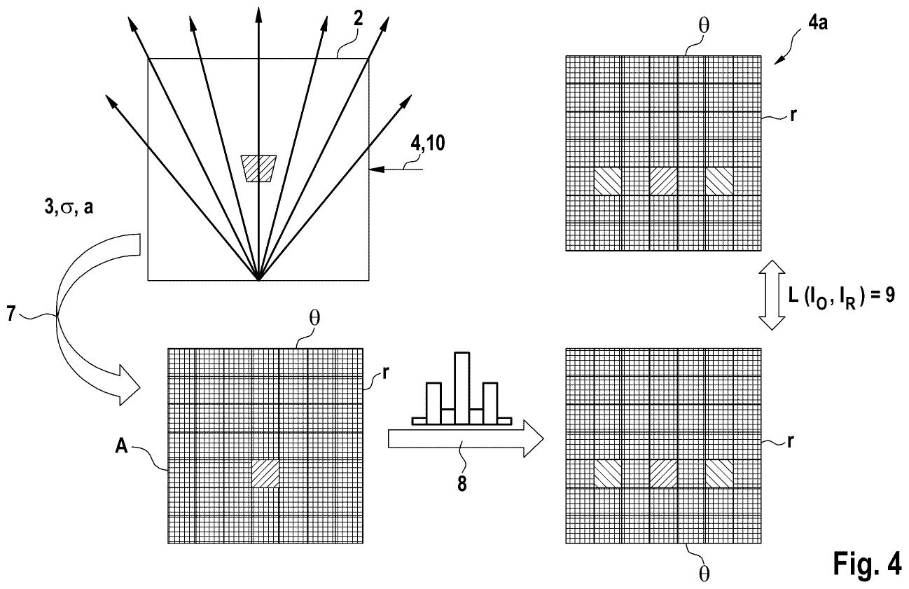

FIG. 4 illustrates how this contradiction is resolved with the method 100. When the trained neural network 2 is supplied with a measurement location 4 or other location 10, the neural network provides local reflection coefficients σ and local transmission coefficients α as characteristic values 3 of the scenery 1. The rendering model 7 provides radar amplitudes A as a function of the distance r from the measuring location 4 and the azimuth angle θ as an ideal observation 4*. The ideal observation 4* obtained with the rendering model 7 is transformed into a real observation 4** by a further measurement model 8. This measurement model 8 models the additional effects that inevitably occur in real observations, here: the generation of sidelobes by the Fourier transform (FFT). The real observation 4** is therefore the observation that is realistically to be expected in measurements. The real observation 4** can be compared with the reference observation 4a, such as the radar spectra shown in FIGS. 2A-2D (presented here as a two-dimensional plot). The result of the comparison can be evaluated using a loss function [symbol] (I₀, I_{R}) as a cost function 9. Here I₀ represents the agreement between the real observation 4** and the reference observation 4a, and I_{R} represents the aforementioned regularization. A realistic optimization goal for the parameters 2a of the neural network 2 is that the real observation 4** ultimately determined from the characteristic values 3 supplied by the neural network 2 is in accordance with the reference observation 4a.

The cost function (loss function) 9 used for this optimization can, in particular, for example also comprise a regularization term in addition to the deviation A between the real observation 4** and the reference observation 4a. The deviation Δ can in particular be evaluated for example with an L1 loss or an L2 loss. The regularization term can in particular comprise for example an L1 loss between the generated real observation 4** and a null tensor. This regularization term optimizes the neural network 2 to predict a reflection coefficient different from zero only when it is actually needed.

Specifically in the application case of radar and lidar data, computational effort can be saved by not considering all possible radar beams when generating the ideal observation 4*, but considering only a certain proportion of the beams along which the highest amplitudes occur. The beams can therefore be sorted, for example, according to the highest amplitudes that occur along the corresponding beam, and then for example the top 20% of the beams sorted in this ranking can be used. The idea behind this is that most of the space in the above-explained “radar cube” is filled with low amplitudes. It is also possible, for example, to start with only the top 1% of the beams in order to learn the peaks in the data, and then, as part of an annealing strategy during the training of the neural network, ideal observations 4* can be used that utilize a successively increased proportion of the beams. As long as the available memory does not represent a limitation, in the end all the beams can be used.

Using only the top n % of the beams has the result that parts of the scenery with high amplitudes are preferred in the radar data during the optimization. This could tend to lead to the neural network predicting characteristic values 3 that result in high amplitudes even in object-free regions of the scenery 1 that are underweighted during training. To counteract this tendency, in addition to the top n % of beams, randomly selected beams from the remaining (non-top n %) portion can also be used to ascertain the ideal observation 4*. In the aforementioned regularization term, these randomly selected beams can optionally be given greater weight.

1-18. (canceled)

19. A method for training a neural network that predicts one or more characteristic values of a scenery that relate to locations observable from a specified measurement location, comprising the following steps:
providing a set of training examples, each training example including at least (i) a measurement location and (ii) a reference observation of the scenery that relates to the measurement location;
for each training example, supplying the measurement location of the training example to the neural network such that the neural network outputs a prediction of the one or more characteristic values;
translating the predicted one or more characteristic values, using a specified rendering model, into an ideal observation of the scenery that is to be expected under idealized conditions when observed from the measurement location; and
translating the ideal observation, using a measurement model, into a real observation of the scenery that is to be expected under realistic conditions when observed from the measurement location, wherein the measurement model represents a process with which the reference observations in the training examples were obtained;
comparing the real observation with the reference observation of the training example;
evaluating, using a specified cost function, a deviation determined during the comparison; and
optimizing one or more parameters that characterize behavior of the neural network with a goal of improving the evaluation by the cost function during further processing of the training examples.

20. The method according to claim 19, wherein:
at least one training example of the training examples additionally contains a specification of an observation direction to which the corresponding reference observation relates, and
the specification of the direction of the observation direction is supplied to the neural network together with the corresponding measurement location as input.

21. The method according to claim 19, wherein parameters that characterize a behavior of the measurement model are optimized with a goal of improving the evaluation by the cost function during further processing of the training examples.

22. The method according to claim 19, wherein the measurement model includes a neural convolutional network that processes its input by sliding application of at least one filter kernel.

23. The method according to claim 19, wherein the measurement model represents:
a physical process and/or simulation process that has contributed to the reference observations of the scenery, and/or
a data evaluation that led to the reference observations of the scenery.

24. The method according to claim 19, wherein:
the set of training examples includes actually carried-out observations of the scenery recorded with a plurality of different devices as the reference observations, and
in processing of each training example, the measurement model is a measurement model related to the device with which the corresponding actually carried-out observation was recorded.

25. The method according to claim 19, wherein the reference observations originate from measurements of a reflection of an electromagnetic or acoustic interrogation radiation sent from the measurement location into the scenery.

26. The method according to claim 25, wherein a reflection coefficient and/or a transmission coefficient, of at least one location in the scenery is selected as a characteristic value of the one of more characteristic value of the scenery.

27. The method according to claim 25, wherein the ideal observation and/or the real observation, includes an intensity value of the reflection as a function of a distance and direction of a location of reflection to the measurement location.

28. The method according to claim 27, wherein the real observation is enriched, compared to the ideal observation, by intensity contributions for additional combinations of distance and direction which do not correspond to any real object in the scenery.

29. The method according to claim 19, wherein:
at least one location is supplied to the trained neural network; and
using the characteristic value provided by the trained neural network, and/or the ideal observation and/or the real observation generated from the characteristic value, a synthetic observation of the scenery is generated.

30. The method according to claim 29, wherein:
a further machine learning model is trained using the generated synthetic observation of the scenery; and/or
a functionality of a technical system for evaluation of observations using the generated synthetic observation of the scenery is tested.

31. The method according to claim 29, wherein:
a traffic situation is selected as the scenery, and
the synthetic observation relates to a modification of the traffic situation which constitutes a violation of traffic rules and/or a hazard.

32. The method according to claim 19, wherein at least one local value of at least one location-dependent function, which individually or together with other location-dependent functions forms a representation of the scenery, is selected as a characteristic value of the at least one characteristic value of the scenery.

33. The method according to claim 32, wherein at least one probability density function of a Gaussian distribution is selected as the at least one location-dependent function.

34. A non-transitory machine-readable data carrier on which is stored a computer program including machine-readable instructions for training a neural network that predicts one or more characteristic values of a specified scenery that relate to locations observable from a specified measurement location, the instructions, when executed by one or more computers and/or compute instances, causing the one or more computers and/or compute instances to perform the following steps comprising:
providing a set of training examples, each training example of the training examples containing at least combinations of measurement locations on the one hand and reference observations of the scenery relating to the measurement locations on the other hand;
for each training example, supplying the corresponding measurement location to the neural network, so that the neural network provides a prediction for the one or more characteristic values;
translating the predicted one or more characteristic values, using a specified rendering model, into an ideal observation of the scenery that is to be expected under idealized conditions starting from the corresponding measurement location;
translating the ideal observation, using a measurement model, into a real observation of the scenery that is to be expected under realistic conditions starting from the corresponding measurement location, wherein the measurement model represents a process with which the reference observations in the training examples were obtained;
comparing the real observation with the reference observations for the corresponding training example;
evaluating a deviation determined during the comparison using a specified cost function; and
optimizing parameters that characterize a behavior of the neural network with a goal of improving the evaluation by the cost function during further processing of the training examples.

35. One or more computers including a non-transitory machine-readable data carrier on which is stored a computer program including machine-readable instructions for training a neural network that predicts one or more characteristic values of a specified scenery that relate to locations observable from a specified measurement location, the instructions, when executed by one or more computers, causing the one or more computers to perform the following steps comprising:
providing a set of training examples, each training example of the training examples containing at least combinations of measurement locations on the one hand and reference observations of the scenery relating to the measurement locations on the other hand;
for each training example, supplying the corresponding measurement location to the neural network, so that the neural network provides a prediction for the one or more characteristic values;
translating the predicted one or more characteristic values, using a specified rendering model, into an ideal observation of the scenery that is to be expected under idealized conditions starting from the corresponding measurement location;
translating the ideal observation, using a measurement model, into a real observation of the scenery that is to be expected under realistic conditions starting from the corresponding measurement location, wherein the measurement model represents a process with which the reference observations in the training examples were obtained;
comparing the real observation with the reference observations for the corresponding training example;
evaluating a deviation determined during the comparison using a specified cost function; and
optimizing parameters that characterize a behavior of the neural network with a goal of improving the evaluation by the cost function during further processing of the training examples.
